(19) United States
(12) Patent Application Publication
(10) Pub. No.: US 2018/0183363 A1
(43) Pub. Date: Jun. 28, 2018

(54) CONTROL DEVICE AND METHOD FOR CONTROLLING THE SAME

(71) Applicant: MABUCHI MOTOR CO., LTD., Matsudo City (JP)

(72) Inventor: Kentaro SAKAMOTO, Matsudo City (JP)

(73) Assignee: MABUCHI MOTOR CO., LTD., Matsudo City (JP)

(21) Appl. No.: 15/808,357

(22) Filed: Nov. 9, 2017

(30) Foreign Application Priority Data
Dec. 28, 2016 (JP) 2016-256923

(51) Int. Cl. H02P 6/06; H02P 3/14; H02P 3/12

(52) U.S. Cl. CPC H02P 6/06; H02P 3/12; H02P 3/14

(57) ABSTRACT

A control device for controlling a motor is provided with: a first reception unit receiving a target value of a rotational speed of the motor; a second reception unit receiving speed information concerning the rotational speed of the motor; a control amount signal output unit determining the control amount based on the speed information and a target value and outputting the control amount signal; and a switch signal output unit outputting, based on the control amount for causing a decrease in the rotational speed due to the brake and indicated by the speed information to reach the target value, a switch signal for switching a torque generation direction of the motor.

### BACKGROUND

### 1. Technical Field

The present invention relates to a control device for controlling a motor by utilizing a regenerative brake or a short-circuit brake and by also using a reverse brake, and to a method for controlling the control device.

### 2. Description of the Related Art

Typical motors may be equipped with a regenerative brake to apply a brake to the motor. The regenerative brake is a technology for converting the kinetic energy of the rotating shaft of a motor into electric energy, whereby the rotating force is decreased and a brake is applied. Modes of motor utilization using the regenerative brake include motors that are used for turning the tires of automobiles, and motors that are used for feeding sheets of paper in printers or scanners, for example. Besides the regenerative brake, a brake may be applied by utilizing a short-circuit brake. A short-circuit brake converts the kinetic energy of a rotating motor shaft into electric energy, which in turn is converted into thermal energy by the electric resistance of the winding wires of the motor itself and dissipated, thereby applying a brake.

A technology concerning a motor in which the regenerative brake is utilized is disclosed in Japanese Patent No. 2956091.

### SUMMARY

When the regenerative brake is used, regenerative braking is provided by decreasing the duty cycle of a motor control amount signal to lower the effective voltage input to the motor. In this case, motor control includes the implementation of a feedback control in which information about the rotational speed of the motor is fed back to reach a target value. If the target value cannot be reached by braking by decreasing the duty cycle, the duty cycle may be made zero. However, with this control technique, a necessary braking force may not be obtained and the speed of the object being driven by the motor may not be sufficiently lowered, resulting in an error in a stop position.

In this case, a reverse brake may be used for braking by applying a torque in the opposite direction from the rotation of the motor. However, because the regenerative brake and the reverse brake have different braking force, when the regenerative brake is switched to the reverse brake, control may be disturbed and the target speed may be missed, resulting in an error in the stop position.

The present invention has been made in view of the above-described problem, and an object of the present invention is to provide a control device with which the speed of a motor in which a brake is applied using a reverse brake as well as a regenerative brake by controlling a duty cycle can be quickly and smoothly reduced to a target speed, thereby enabling the motor to stop at a target position.

In order to solve the problem, according to an aspect of the present invention, there is provided a control device for controlling a motor which is driven by being applied with an effective voltage corresponding to a control amount of a control amount signal, and in which, when an inversely induced voltage of the motor exceeds the effective voltage being applied, a rotational motion of a rotating shaft of the motor is converted into electric energy for use as a brake. The control device includes a first reception unit that receives a target value of the rotational speed of the motor; a second reception unit that receives speed information concerning the rotational speed of the motor; a control amount signal output unit that, based on the speed information and the target value, determines the control amount, and that outputs a control amount signal; and a switch signal output unit that, based on the control amount for causing a decrease in the rotational speed due to the brake and indicated by the speed information to reach the target value, outputs a switch signal for switching a torque generation direction of the motor.

In order to solve the problem, according to an aspect of the present invention, there is provided a control device for controlling a motor which is driven by being applied with an effective voltage corresponding to a duty cycle of a control amount signal, and in which input terminals of the motor are short-circuited to convert rotating motion of a rotating shaft of the motor into thermal energy for use as a brake. The control device includes a first reception unit that receives a target value of a rotational speed of the motor; a second reception unit that receives speed information concerning the rotational speed of the motor; a control amount signal output unit which, based on the speed information and the target value, determines the duty cycle and outputs the control amount signal; a drive signal output unit that outputs a drive signal for controlling the short circuit between the input terminals using a brake duty cycle; and a switch signal output unit that outputs a switch signal for switching a torque generation direction of the motor. The control amount signal output unit has a dead band in which neither a drive torque for driving the motor with the control amount signal nor a brake torque by the brake are produced, and is provided with a conversion formula for converting an output value of the drive signal and an output value of the control amount signal output unit. The switch signal output unit outputs the switch signal in a range in which the brake duty cycle for causing a decrease in the rotational speed due to the brake and indicated by the speed information to reach the target value has a lower limit of a converted value obtained by converting an upper limit value of the duty cycle of the control amount signal in the dead band into the brake duty cycle, and an upper limit of 100%.

In order to solve the problem, according to an aspect of the present invention, there is provided a control method for a control device controlling a motor which is driven by being applied with an effective voltage corresponding to a control amount of a control amount signal, and in which, when an inversely induced voltage of the motor exceeds the effective voltage being applied, a rotational motion of a rotating shaft of the motor is converted into electric energy for use as a brake, the control device having a dead band in which neither a drive torque for driving the motor with the control amount nor a brake torque by the brake are produced. The control method includes a first receiving step of receiving a target value of a rotational speed of the motor; a second receiving step of receiving speed information concerning the rotational speed of the motor; a control amount signal output step of determining the control amount based on the speed information and the target value, and outputting a control amount signal; and a switch signal output step of outputting a switch signal for switching a torque generation direction of the motor when the control amount for causing a decrease in the rotational speed due to the brake and indicated by the speed information to reach the target value has an absolute value less than or equal to an upper limit value of the control amount causing the dead band.

In the control device, the switch signal output unit may output the switch signal at the timing of the control amount for reaching the target value becoming zero.

In the control device, the control amount signal output unit may output the control amount signal that is corrected so as to become greater than or equal to the control amount of a dead band in which neither a drive torque for driving the motor with the control amount signal nor a brake torque by the brake are produced.

The switch signal output unit may output the switch signal for switching the torque generation direction of the motor when the control amount for causing the decrease in the rotational speed due to the brake and indicated by the speed information to reach the target value has an absolute value less than or equal to an upper limit value of the control amount causing the dead band.

In the control device, the control amount signal output unit may increase the control amount signal after the switch signal is output.

In the control device, the control amount signal output unit may determine the control amount based on the target value and a speed deviation of the motor based on the speed information.

In the control device according to an aspect of the present invention, when the transition of duty cycle has a predetermined value, the switch signal for changing the torque generation direction of the motor is output at a predetermined timing to change the drive direction of the motor. Accordingly, the control signal for driving can be used as a signal input for braking, whereby the speed of the motor can be quickly and smoothly reduced by a simple configuration.

### BRIEF DESCRIPTION OF THE DRAWINGS

FIG. 1 is a block diagram of a functional configuration example of a control device;

FIG. 2 is a flowchart of an operation of the control device;

FIGS. 3A and 3B are graphs for describing a duty cycle in a motor braking control by the control device;

FIG. 4A is a graph illustrating a typical control example FIG. 4B is a graph illustrating a control example by the control device of the present invention;

FIG. 5 is a graph for describing a duty cycle in a braking control using a short-circuit brake; and

FIG. 6 is a graph for describing a duty cycle in a braking control using a short-circuit brake.

### DESCRIPTION OF THE EMBODIMENTS

### <Finding of the Inventors>

When a motor is controlled by pulse width modulation (PWM) control, the duty cycle, which indicates the proportion of time in which the pulse signal is High in one period (or, in the case of a negative logic circuit, the proportion of time in which the pulse signal is Low in one period), is controlled to control the rotational speed of the motor. In a positive logic circuit, it is possible to turn a motor by increasing the effective voltage applied to the motor to thereby increase the proportion of the High pulse signal. On the other hand, in order to stop the rotation of the motor, braking is performed by decreasing the duty cycle and also by converting the rotational motion of the motor, which would keep rotating due to inertia, into electric energy which is dissipated. In the case of a negative logic circuit, the above discussion may be considered by interchanging High and Low.

The inventors have discovered that even when the duty cycle is made zero during the braking of the motor, in some cases it is impossible to quickly reduce the speed of the object being driven by the rotation of the motor, and to cause the object to be stopped at the target position. It has also been discovered that, depending on the duty cycle and the rotational speed, one of the causes for the inability to apply a brake to the motor with a required braking force is the presence of a dead band in which neither a drive torque nor a brake torque are produced, resulting in a total loss of braking. Another discovery was that, when the regenerative brake is switched to the reverse brake in order to compensate for a lack of braking force, a discrepancy between the rotational speed and the target speed may arise if the switch is performed based on the number of rotations, depending on differences in the load state of the motor. A servo motor equipped with an electric current sensor may be used to control the torque and electric currents in the forward and reverse directions. In this case, the target speed may be quickly reached by actively adjusting the braking force while the torque generation direction is changed, starting from the duty cycle of 50%. However, such servo motors often require a control device equipped with a highly sophisticated computing unit, in addition to the current and torque sensors, thus resulting in high cost.

The inventors have arrived at the invention which employs a motor that can produce a torque in both normal rotation and reverse rotation directions is used, and an inexpensive gate driver IC that operates with the three commands of motor activation/stop, torque generation direction, and duty cycle, and, when the duty cycle for a control to reach a motor rotation target value becomes lower than a predetermined value, the duty cycle is increased by switching the torque generation direction at a predetermined timing with respect to the motor. The inventors have also arrived at the invention in which, in order to eliminate the dead band in the motor, the duty cycle which is in a dead band range computationally is corrected to a certain value or more and then output.

In the following, a scheme for implementing an embodiment of a control device of the present invention will be described with reference to the drawings.

### First Embodiment

### <Configuration>

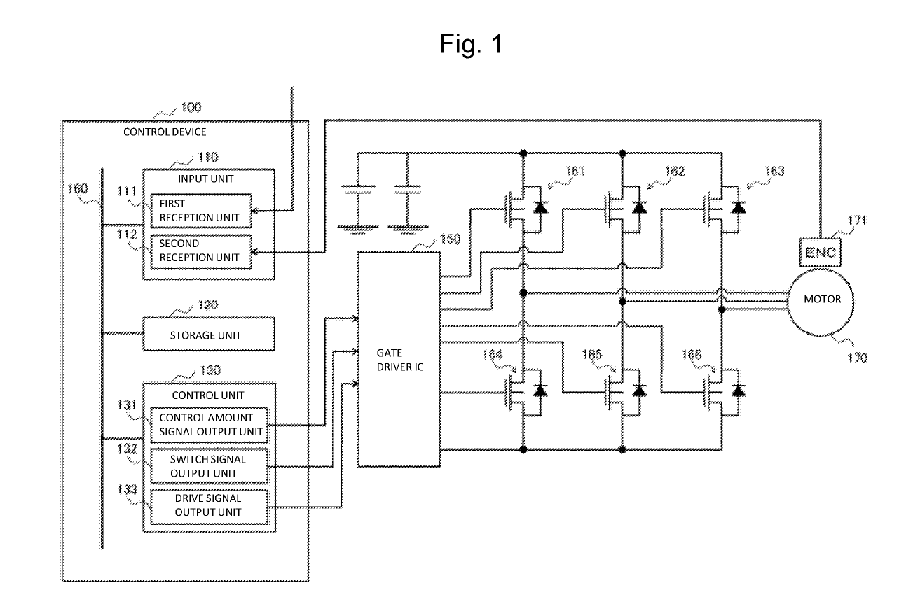

FIG. 1 is a block diagram of a configuration example of the control device of the present invention.

As illustrated in FIG. 1, the control device 100 includes a first reception unit 111, a second reception unit 112, a control amount signal output unit 131, a switch signal output unit 132, and a drive signal output unit 133.

The control device 100 is a control device for controlling a motor, and may be implemented using a processor, a microcomputer, a gate driver IC, and the like. The control device 100 may control a gate driver IC that outputs a control signal to the motor, or directly control transistors 161 to 166 for switching the supply of electricity to the motor 170. The motor is a motor 170 that is driven by the application of an effective voltage corresponding to the duty cycle of a control amount signal that is a pulse signal. Specifically, the motor 170 is a motor driven by a control technique generally referred to as pulse width modulation (PWM) control. The motor 170 can convert the kinetic energy of its rotation due to inertia into electric energy for regenerative braking.

The first reception unit 111 receives a target value (command value) for the rotational speed of the motor. That is, the first reception unit 111 receives speed instruction information from an external device, for example. The first reception unit 111 is an interface for receiving the target value, and may be provided by a terminal of the control device 100, for example and not by way of limitation. The target value may be generated in the control device 100 and received.

The second reception unit 112 receives speed information concerning the rotational speed of the motor. That is, feedback information concerning the actual speed of the rotational speed of the driving motor is received. The second reception unit 112 is an interface for receiving the speed information, and may be provided by a terminal of the control device 100, for example and not by way of limitation.

The control amount signal output unit 131, on the basis of the target value received by the first reception unit 111 and the speed information received by the second reception unit 112, determines the duty cycle of the control amount signal, and outputs a control amount signal based on the determined duty cycle. The control amount signal output unit 131 basically increases the duty cycle when the speed information indicates a value smaller than the target value, and decreases the duty cycle when the speed information indicates a value greater than the target value. The duty cycle, in the case of a positive logic circuit, is the proportion of time in which the pulse signal for driving the motor is High in one period; i.e., the proportion of time in which the pulse signal is High per unit time. In the case of a negative logic circuit, the duty cycle is the proportion of time in in which the signal is Low in one period. The duty cycle may be determined on the basis of the target value and the speed information. For example, the duty cycle may be determined from a speed deviation, or a position deviation identifiable from the speed information, and the target value. The control unit 130 may send a command to a gate driver IC 150 as a pulse signal, an analog voltage value, or a frequency signal.

The switch signal output unit 132 outputs a switch signal for switching the torque generation direction of the motor. The switch signal output unit 132 outputs the switch signal for switching the torque generation direction of the motor when it is determined that a decrease in the rotational speed indicated by the speed information received by the second reception unit 112 would not reach the target value received by the first reception unit 111. The switch signal may simply be a High/Low signal indicating the switching between normal rotation and reverse rotation.

The drive signal output unit 133 outputs signals indicating the starting of the motor and the stopping of the motor. The starting signal and the stopping signal may simply be signals indicating High and Low. When the stopping signal is output, the winding wire of one phase or a plurality of phases of the motor is short-circuited, and, when the motor is rotating, a short-circuit brake is applied to the motor.

The control device 100 also includes an input unit 110, a storage unit 120, and a control unit 130. The input unit 110, the storage unit 120, and the control unit 130 are connected via a bus 160.

The input unit 110 is an interface with the function of receiving the input of external signals. The input unit 110 includes the first reception unit 111 and the second reception unit 112 described above.

The first reception unit 111 successively receives from an external device (not illustrated) connected to the control device 100 information indicating the target value for the rotational speed of the motor, and transmits the received target value to the control unit 130 via the bus 160.

The second reception unit 112 successively receives from an encoder 171 attached to the motor 170 information concerning the operating state of the motor 170, including speed information indicating the rotational speed of the motor 170, and transmits the received speed information to the control unit 130 via the bus 160.

The storage unit 120 is a storage medium with the function of storing various program and data that the control device 100 requires for operation. The storage unit 120 may include a read only memory (ROM), a hard disk drive (HDD), a solid state drive (SSD), or a flash memory, for example. The storage unit 120 has stored therein a control program for generating a signal for outputting an instruction to the gate driver IC 150 in accordance with the input target value and the speed information.

The control unit 130 is a processor with the function of controlling the various units of the control device 100 by executing the program stored in the storage unit 120. The control unit 130, by executing the control program stored in the storage unit 120, functions as the control amount signal output unit 131, the switch signal output unit 132, and the drive signal output unit 133.

The control amount signal output unit 131 determines the duty cycle of the signal for PWM control from the target value transmitted to the control unit 130 and the speed information, and outputs a control amount signal pulse having the determined duty cycle to the gate driver IC 150. The control amount signal output unit 131 has the target value and speed information successively transmitted thereto, and successively updates the duty cycle. The details of feedback control for determining the duty cycle on the basis of a target value and speed information are typically known, and will therefore be omitted. The control amount signal output unit 131 outputs a control amount signal (such as a pulse signal) corresponding to the calculated duty cycle. The control amount signal output unit 131 may be configured to implement a control such that, when a sudden braking is to be applied, the duty cycle is rapidly decreased to apply a regenerative brake, and, if the braking force is still lacking, the control amount signal output unit 131 increases the duty cycle after the switch signal output unit 132 has output a switch signal, thereby applying a reverse brake.

The switch signal output unit 132 outputs the switch signal at the timing at which the duty cycle, calculated by the control amount signal output unit 131 from the target value transmitted to the control unit 130 and the speed information, transitions to zero. In this way, with respect to the normal rotation torque of the kinetic energy of the motor 170, a negative rotation torque is given for a control to the target speed. Because the torque generation direction is switched at the timing of zero duty cycle, the behavior of the motor after switching tends not to become destabilized. Thus, the control device 100 capable of stably operating the motor 170 can be provided.

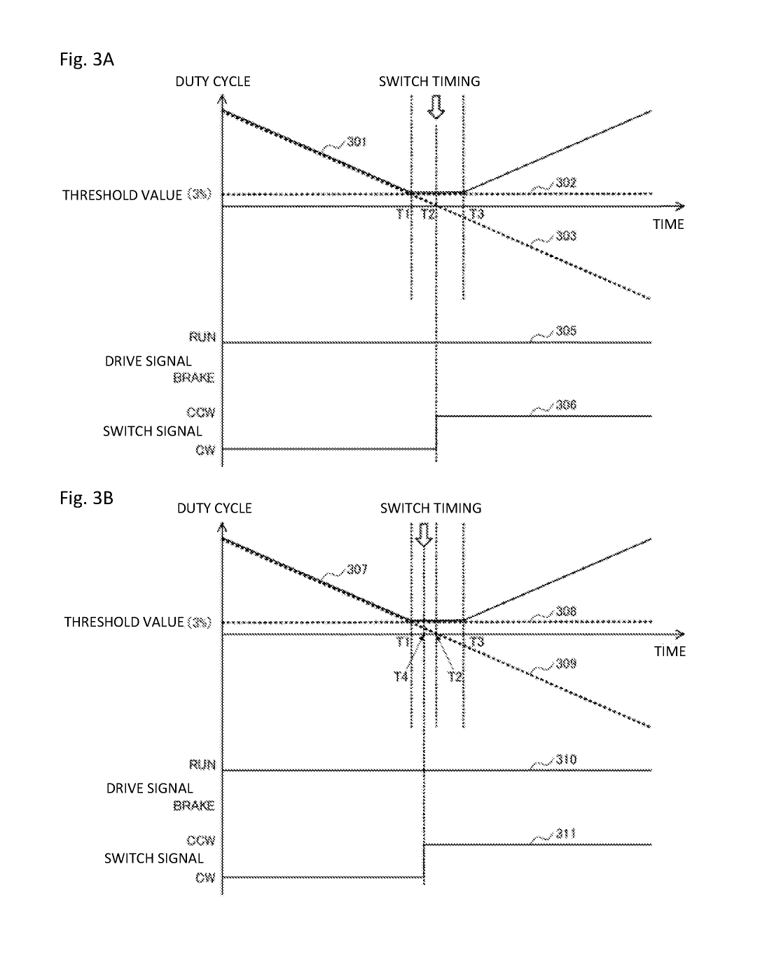

Referring to FIG. 3, the switch instruction from the switch signal output unit 132 concerning the torque generation direction of the motor, and the transition of duty cycle will be described. FIGS. 3A and 3B illustrate changes in a conventional control value for duty cycle, an actual instruction value, a drive signal, and a switch signal in a case where the control is performed in the direction for stopping the motor rotation.

In the graph of upper side of FIG. 3A, a dashed line 303 indicates the transition of the duty cycle of the drive signal during the braking operation. As indicated by the dashed line 303 in FIG. 3A, during the motor braking operation, the desired value of the duty cycle may become a negative value. Such event tends to often occur when the instructed speed target value is low and the speed indicated by the speed information is high. However, in the case of a regenerative brake, the duty cycle can only be made zero for output, resulting in the possibility that the motor cannot be braked to the target speed.

Accordingly, the switch signal output unit 132 of the control device 100, in order to change the torque generation direction of the motor 170 to function as a reverse brake, switches the signal designating the torque generation direction. Specifically, the switch signal output unit 132 outputs a switch signal 306, as illustrated in FIG. 3A, switching from forward rotation to reverse rotation at the timing T2 of the duty cycle becoming zero (the timing of the dashed line 303 becoming zero). In response to the switch signal 306, the gate driver IC 150 outputs an instruction to the motor 170 to make the switching of torque generation direction for reverse rotation.

In the course of making the invention, the inventors discovered that, when the control amount signal is a signal of a low duty cycle, synchronization rectification of the gate driver IC 150 cannot be performed and a brake by regeneration cannot be applied, resulting in the dead band in which the motor 170 runs idle. The inventors, having made the discovery that in the dead band, the regenerative brake becomes even less effective, arrived at the invention of the control device 100, in which the dead band is avoided by identifying the duty cycle at which the dead band develops (for example, 2.8%), and outputting a control amount signal in which a correction is made such that the duty cycle has a threshold value or more with a margin for errors due to component quality variations and the like. Accordingly, the control amount signal output unit 131 controls the motor 170 so that, as indicated by a solid line 301, the duty cycle becomes at least 3% including the 2.8% with 0.2% for an error (section T1 to T3 in FIG. 3A). Hereafter, the dead band refers to the range including the margin.

Then, as indicated by the solid line 301, the duty cycle is increased from timing T3, whereby the motor 170 is supplied with a reverse rotation torque for braking. If the braking is excessive, the torque generation direction is again reversed. By repeating this process, it becomes possible to brake the motor 170 to the target speed.

In the embodiment, the switch signal output unit 132 is configured to output the switch signal at the timing T2 at which the duty cycle transitions to zero. This, however, is not intended as a limitation.

At the timing of activating the reverse brake by changing the torque generation direction of the motor 170, it becomes easy to switch the torque generation direction and to smoothly transition to the reverse brake if the electric current supplied to the coils of the motor 170 is small.

Accordingly, the timing for activating the reverse brake may be when the absolute value of the duty cycle calculated on the basis of the target value and the speed information (dashed line 303 in FIG. 3) is not greater than the duty cycle of the threshold value for avoiding the dead band (between T1 and T3 in FIG. 3).

For example, FIG. 3B illustrates the case in which the switching takes place at T4 between T1 and T2. In this case, the transmission timing for the switch signal indicated by a solid line 311 is T4. The output of control amount signal is indicated by a solid line 307 which maintains the duty cycle of the threshold value for avoiding the dead band between T1 and T3. Thus, the transition of the duty cycle output by the control amount signal output unit 131 is not changed from the case of FIG. 3A in which the switching takes place at the timing T2 when the duty cycle is zero.

In FIGS. 3A and 3B, for sake of brevity, examples of the changes in duty cycle are illustrated by a linear function. However, the change in duty cycle is not limited to a linear function. The switching from regenerative brake to reverse brake may be implemented on the basis of the duty cycle of the threshold value for avoiding the dead band, even in the case of a multi-degree function or an exponential function, or in a non-linear case.

In FIGS. 3A and 3B, the lines are displaced from each other for the sake of clarity of the drawings. In reality, in FIG. 3A, the solid line 301 and the dashed line 303 substantially overlap until time T1, and in FIG. 3B, the solid line 307 and the dashed line 309 substantially overlap until time T1.

The configuration of the control device 100 has been described.

The gate driver IC 150 is, for example, a commercially available integrated circuit for driving motors by PWM control. The gate driver IC 150 applies, to a three-phase bridge circuit including the transistors 161 to 166 and the motor 170, an effective voltage corresponding to the duty cycle of the received control amount signal. In order to control the motor 170, the gate driver IC 150 switches, as appropriate, the ON/OFF of the transistors 161 to 166 so as to drive the motor 170 or to enable collection of energy by regeneration. The timing of ON/OFF and switching of the transistors 161 to 166 is typically known technology, and its description is therefore omitted herein.

The transistors 161 to 166 are turned ON or OFF by the gate driver IC 150 and conduct at the ON timing so as to cause electric current to flow through the motor 170, or to allow the flow of electric current generated by regeneration by the motor 170. Depending on the combination of those of the transistors 161 to 166 that are turned ON, a drive electric current flows or a regeneration electric current flows. When the effective voltage applied to the three-phase bridge circuit is greater than an inversely induced voltage of the motor, drive electric current flows; when the applied effective voltage is smaller than the inversely induced voltage, regeneration electric current flows.

The motor 170 is driven in accordance with the voltage applied from the gate driver IC 150 to perform position control, e.g., for gears used in a sheet feeding mechanism in a printer and the like. The motor 170 also functions as an electric power generator that generates electric power using the rotational energy of the shaft turning by inertia. In this case, the rotational energy (kinetic energy) is converted into electric energy, the transistor 161 to 166 are appropriately switched by the control unit 130 and the gate driver IC 150 in synchronization with the rotation of the motor 170, and the electric energy is sent to the power supply side to provide the function of a regenerative brake for braking the rotation of the motor 170. The motor 170 is a three-phase brushless motor, for example. The motor 170 is not limited to a three-phase brushless motor operated in a three-phase bridge circuit, and may be a brush motor operated in an H-bridge circuit, for example.

An encoder (ENC) 171 is an encoder for detecting the state of the motor. The ENC 171 senses the drive state of the motor 170 and at least detects its rotational speed, and outputs speed information to the control device 100.

By the above configuration, the control device 100 controls the driving of the motor 170.

### <Operation>

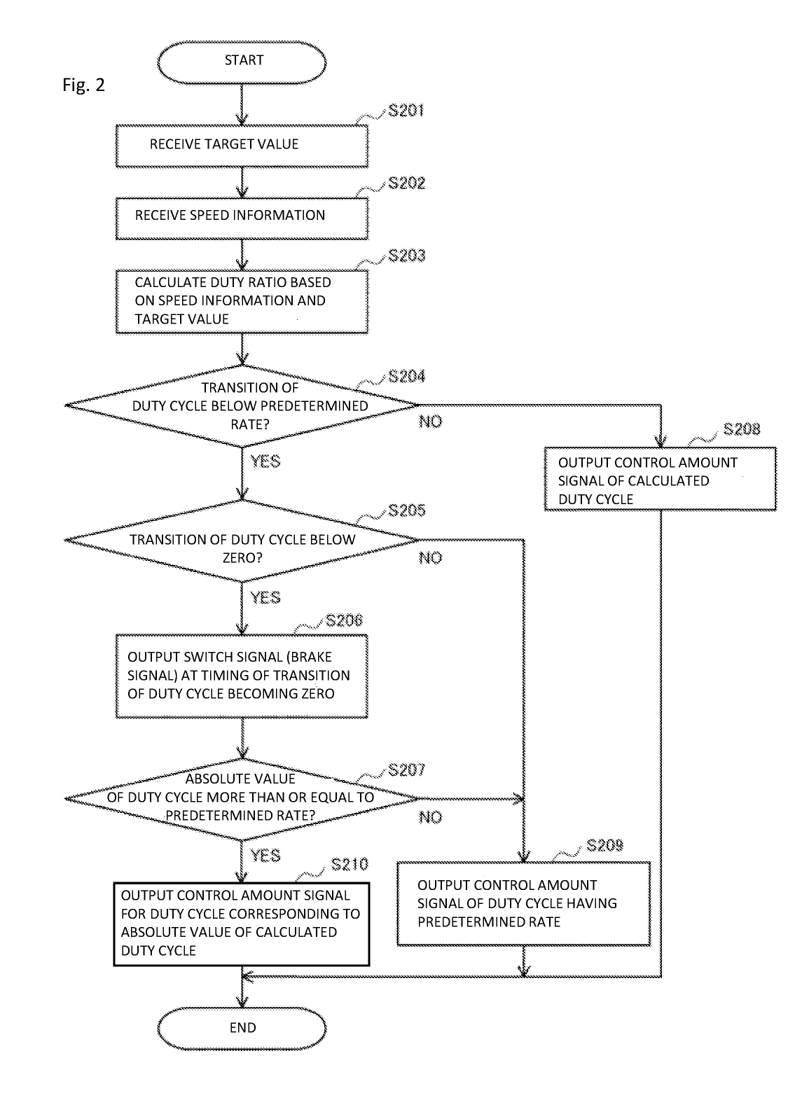

FIG. 2 is a flowchart of a control operation of the control device 100, illustrating the operation during braking.

### (Step S201)

In step S201, as illustrated in FIG. 1, the first reception unit 111 of the control device 100 receives from an external device a target value of the number of rotations of the motor. The input unit 110 transmits the target value received by the first reception unit 111 to the control unit 130 via the bus 160, and transitions to step S202.

### (Step S202)

In step S202, the second reception unit 112 of the control device receives the speed information from the ENC 171. The input unit 110 transmits the speed information received by the second reception unit 112 to the control unit 130 via the bus 160, and transitions to step S203. As long as the control unit 130 can appropriately collect the target value and the speed information, the order of execution of step S201 and step S202 may be switched, or the steps may be performed in parallel.

### (Step S203)

In step S203, the control amount signal output unit 131 determines the duty cycle of the control amount signal to be output on the basis of the transmitted speed information and the target value and in accordance with a predetermined algorithm for calculating a pre-fixed duty cycle, and transitions to step S204.

### (Step S204)

In step S204, the control amount signal output unit 131 determines whether the determined duty cycle becomes a predetermined value or less. The predetermined rate refers to the duty cycle of the control amount signal below which the motor 170 will be in the dead band where neither a drive torque nor a brake torque are generated. For example, when the ratio (upper limit) at which the dead band begins to develop is 2.8%, the predetermined rate is set to 3.0% including some margin for error due to component quality variations and the like. Because the ratio may vary depending on the performance of the motor 170 or the circuit configuration, the percentage may be identified by driving the motor 170 in advance, and set in the storage unit 120 of the control device 100. If the duty cycle is below the predetermined rate (YES), the process transitions to step S205. If the duty cycle is more than or equal to the predetermined rate (NO), the process transitions to step S208.

### (Step S205)

In step S205, the switch signal output unit 132 determines whether the duty cycle calculated by the control amount signal output unit 131 is below zero, i.e., a negative value. If the duty cycle has a negative value (YES), the process transitions to step S206. If the duty cycle does not become a negative value (NO), the process transitions to step S209.

### (Step S206)

In step S206, the switch signal output unit 132 outputs the switch signal at the timing of the determination of transition of the duty cycle to zero, and transitions to step S207.

### (Step S207)

In step S207, the control amount signal output unit 131 determines whether the absolute value of the determined duty cycle is a predetermined rate or more. The predetermined rate refers to the duty cycle of the control amount signal below which the motor 170 is in the dead band in which neither a drive torque nor a brake torque are generated. The ratio is the same as the ratio set in S204. If the duty cycle has a value greater than the predetermined rate (YES), the process transitions to step S210. If the duty cycle is below the predetermined rate (NO), the process transitions to step S209.

### (Step S208)

In step S208, the control amount signal output unit 131 outputs the control amount signal for the calculated duty cycle and comes to an end.

### (Step S209)

In step S209, the control amount signal output unit 131 outputs the control amount signal for the duty cycle of the predetermined rate set in advance (such as 3%), and comes to an end.

### (Step S210)

In step S210, the control amount signal output unit 131 outputs the control amount signal for the duty cycle corresponding to the absolute value of the calculated duty cycle (negative value), and comes to an end. The output may be a value obtained by multiplying the absolute value of the calculated duty cycle by a predetermined number, such as a number in a range of from 0.5 to 2.

The flowchart of FIG. 2 describes the case in which the switching takes place when the duty cycle calculated from the target value and the speed information is zero. When the switching takes place at the duty cycle of other than zero, the “0” in step S205 and step S206 should be replaced by “the duty cycle for switching the torque direction”.

The control device 100 repeats the process illustrated in FIG. 2 and controls the motor 170 until power supply is turned OFF or an instruction to end the control of the motor 170 is received. If, as a result of the braking by applying a torque to the motor 170 in the opposite direction, the motor 170 drops below the target speed, the direction of the torque applied to the motor 170 is switched again. By performing the switching between reverse rotation torque and normal rotation torque, it becomes possible to reduce the speed of the motor 170 to the target speed.

### <Consideration>

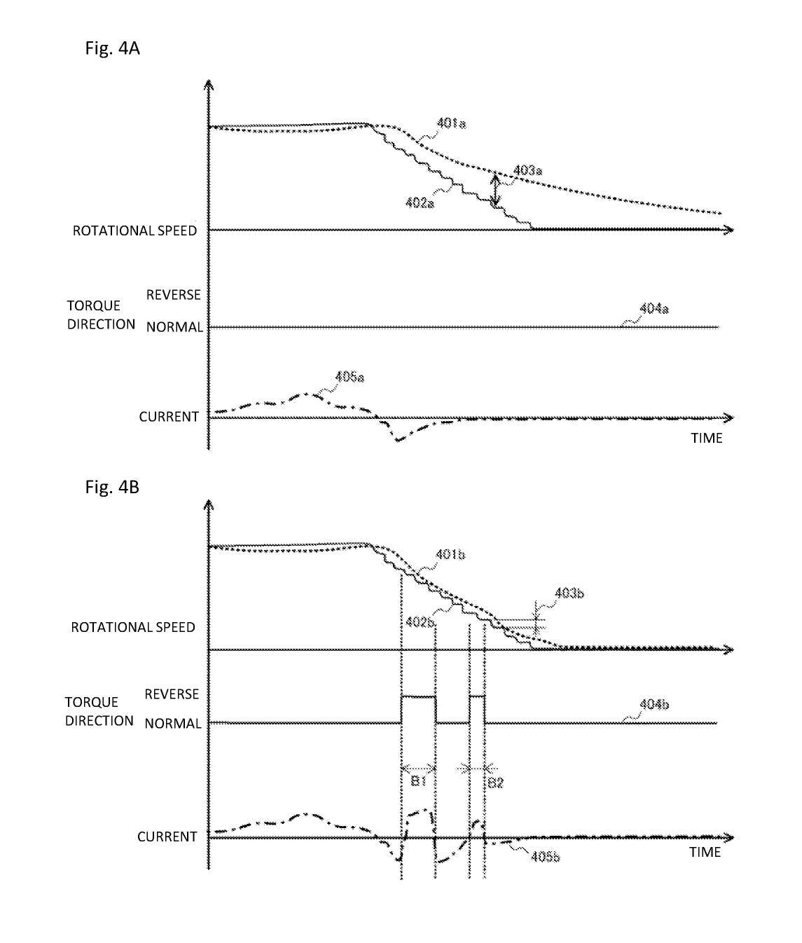

FIG. 4A is a graph illustrating a signal state example concerning a control in a case where a motor braking operation is performed according to typical technique.

In FIG. 4A, a dashed line 401a indicates the transition of the actual speed of motor rotation based on the speed information obtained from the encoder. On the other hand, a solid line 402a indicates the target value for the rotational speed of the motor. A solid line 404a indicates the torque generation direction for driving the motor. In the example of typical regenerative braking, the torque generation direction of the motor is the forward rotation direction at all times; hence the state of FIG. 4A indicating the forward rotation direction at all times. A dashed and single-dotted line 405a indicates an actual example of an electric current flow through a three-phase bridge circuit. In FIG. 4A, because the switch signal is in the normal direction, when the dashed and single-dotted line 405a is in the positive position of the graph, this indicates a state in which the motor is producing a normal rotation torque. When in the negative direction, this indicates a state in which a brake is being applied by regenerative braking.

Referring to FIG. 4A, when braking is provided by a regenerative brake by performing the typical control to decrease the duty cycle, the inversely induced voltage produced by the motor decreases as the rotational speed decreases, and the regeneration electric current becomes smaller. Accordingly, the regenerative brake becomes ineffective, resulting in a discrepancy, indicated by a difference 403a, between the target value and the actual speed.

FIG. 4B is a graph illustrating a signal state example concerning a control in a case where braking operation for the motor 170 is performed using the technique according to the present embodiment.

As illustrated in FIG. 4B, by applying a reverse brake (control by switching the torque generation direction of the motor), it becomes possible to implement a control such that the difference 403b between the target value 402b and the actual speed 401b is decreased compared with the typical example, and the actual speed follows the target value. In FIG. 4B, an interval B1 and an interval B2 are the intervals in which the reverse brake is being applied, and a solid line 404b indicates the switch signal output to the motor 170. It will be appreciated that the direction of torque produced is switched in interval B1 and interval B2. It will also be appreciated that, as a result of the application of the reverse brake, the value of electric current that flows through the three-phase bridge circuit is reversed in interval B1 and interval B2, as indicated by a dashed and single-dotted line 405b.

In addition, the control device 100 has the configuration in which, in order to eliminate the interval in which the brake torque by regeneration is not produced, the duty cycle of the drive signal is not decreased below a predetermined value (for example, 3%). The configuration makes it possible to achieve a smoother braking during the control of the motor 170.

### Summary of First Embodiment

As described above, the control device 100, when the transition of the duty cycle determined on the basis of a target value and speed information drops below a predetermined value, and particularly when it becomes a negative value, outputs an instruction signal for switching the torque generation direction of the motor, whereby a reverse brake can be applied. Specifically, there is provided the control device 100 which makes it possible to achieve sudden braking to a target position that would not be achievable by braking by a regenerative brake alone, without using an expensive servo motor. The control device 100 of the present invention is particularly useful for motor braking control using an inexpensive gate driver IC only capable of applying a positive control amount signal for PWM control.

### Second Embodiment

While in the first embodiment, as a control means, a regenerative brake and a reverse brake are used in combination, a short-circuit brake may be used instead of the regenerative brake. In the second embodiment, the signal output by the drive signal output unit 133 in the first embodiment is switched from RUN to BRAKE to provide a short-circuit brake. When the output signal from the drive signal output unit 133 is BRAKE, the gate driver IC 150 short-circuits terminals of the motor, and controls the transistors 161 to 166 to form a closed circuit consisting of the winding wires of one or a plurality of phases of the motor.

When the braking by a short-circuit brake is implemented, the drive signal output unit 133 performs PWM control and thereby determines the duty cycle for the short-circuit brake from the target value transmitted to the control unit 130 and the speed information, as in the case of a regenerative brake. The drive signal output unit 133 then outputs a drive signal for the determined short-circuit brake duty cycle to the gate driver IC 150. The drive signal output unit 133 has the target value and speed information successively transmitted thereto, and successively updates the short-circuit brake duty cycle. Because the short-circuit brake has different braking force from the regenerative brake, a formula for converting the duty cycle for short-circuit brake into the duty cycle for motor drive and regenerative brake (hereafter denoted by a motor drive duty cycle for distinction) is stored in the storage unit 120, and the control unit 130 implements braking by utilizing the stored formula.

The drive signal output unit 133 outputs a drive control amount signal corresponding to the calculated duty cycle. When sudden braking is to be applied and if it is determined that the required braking force would not be obtained even when the duty cycle for short-circuit brake reached an upper limit value (100%), the drive signal output unit 133 is configured to apply a reverse brake by implementing a control such that the drive control amount signal is made RUN after the switch signal is output from the switch signal output unit 132, and the motor drive duty cycle of the control amount signal output unit 131 is increased.

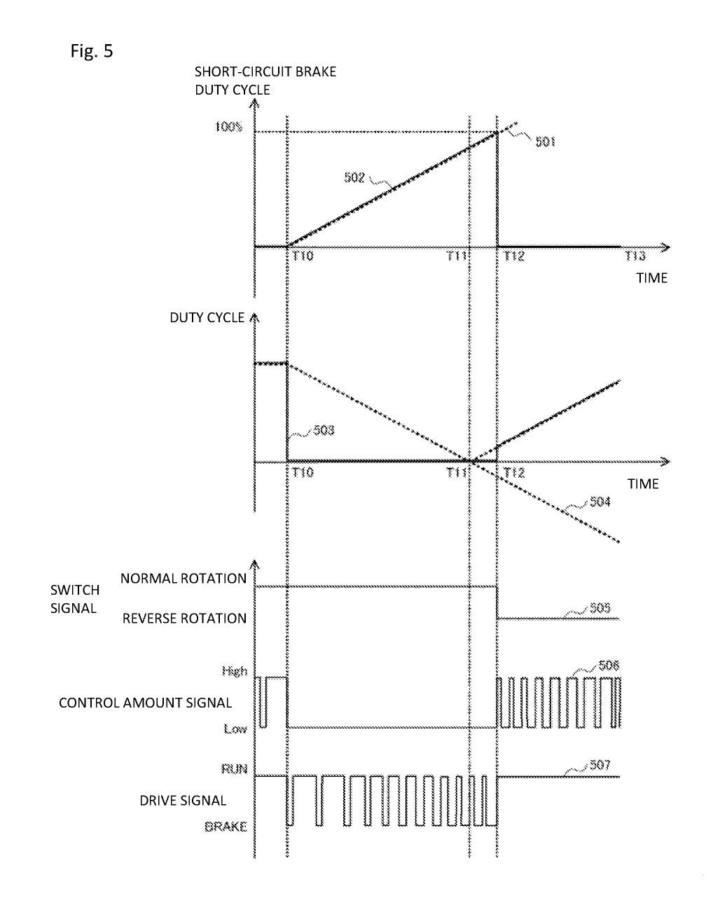

Referring to FIG. 5, the instruction by the switch signal output unit 132 for switching the torque generation direction of the motor and the transition of duty cycle will be described. FIG. 5 illustrates changes in the calculated value of the duty cycle based on the target value and the speed information; the actual instruction value of the duty cycle to the gate driver IC; the drive signal; the switch signal; and the control amount signal, in the case of implementing a control in the direction for stopping the motor rotation where a short-circuit brake is used.

In the upper graph of FIG. 5, a dashed line 501 indicates the transition of the calculated value of the short-circuit brake duty cycle of the drive signal based on the target value and the speed information during braking operation. As indicated by the dashed line 501 in FIG. 5, a desired value of the duty cycle of a short-circuit brake during the motor braking operation may exceed 100%. Such event tends to occur in a case where an instruction for a rapid reduction in speed is issued when the rotational speed of the motor is high. In this case, typically, there is no choice but to output the duty cycle of the short-circuit brake at the upper limit value, i.e., 100%, resulting in the possibility that the motor cannot be braked to the target speed.

In this case, the actual instruction value for the motor drive duty cycle is indicated by a solid line 503 in the second-row graph in FIG. 5. As indicated by a dashed line 504, the calculated value of the motor drive duty cycle as converted for the case of reducing the speed by a regenerative brake would become a negative value, as in the first embodiment. The difference between time T11 and time T12, i.e., the disagreement between the short-circuit brake duty cycle of 100% and the motor drive duty cycle of 0%, is due to the above-described difference between the braking force by a regenerative brake and the braking force by a short-circuit brake.

Accordingly, the switch signal output unit 132 of the control device 100 is switched to the reverse rotation direction, and the motor drive duty cycle of the control amount signal output unit 131 is increased to provide the function of a reverse brake. Specifically, the switch signal output unit 132, as illustrated by a switch signal 505 and a drive signal 507 in FIG. 5, causes a torque in the opposite direction to the rotating direction at the timing of the short-circuit brake duty cycle becoming 100% T12 (when the dashed line 501 becomes 100%). Specifically, at the timing T12 where the short-circuit brake duty becomes 100%, the switch signal 505 is switched from forward rotation to reverse rotation. As indicated by the drive signal 507, first, the time for short circuit (time of Low) is extended to provide the function of a short-circuit brake. Then, at the timing of the short-circuit brake duty cycle reaching 100%, the torque generation direction of the motor 170 is switched, and then the control amount signal is increased to provide the function of a reverse brake. In this way, even when it appears unlikely that a speed reduction to the target speed can be achieved by the braking by a short-circuit brake, the target speed can be reached by applying a reverse brake. As described above, because there is a difference in braking force between the regenerative brake and the short-circuit brake, the control amount signal output unit 132 calculates and outputs the motor drive duty cycle at T12. In this way, the short-circuit brake can be smoothly switched to the reverse brake. When the braking by the short-circuit brake is excessive (i.e., the speed is reduced below the target speed), the torque generation direction is again reversed. By repeating this process, it becomes possible to brake the motor 170 to the target speed.

While the second embodiment is configured such that, for the switching from a short-circuit brake to a reverse brake, the switch signal is output at the timing T12 when the transition of the duty cycle for a short-circuit brake becomes 100%, as illustrated in FIG. 5, this is not intended as a limitation.

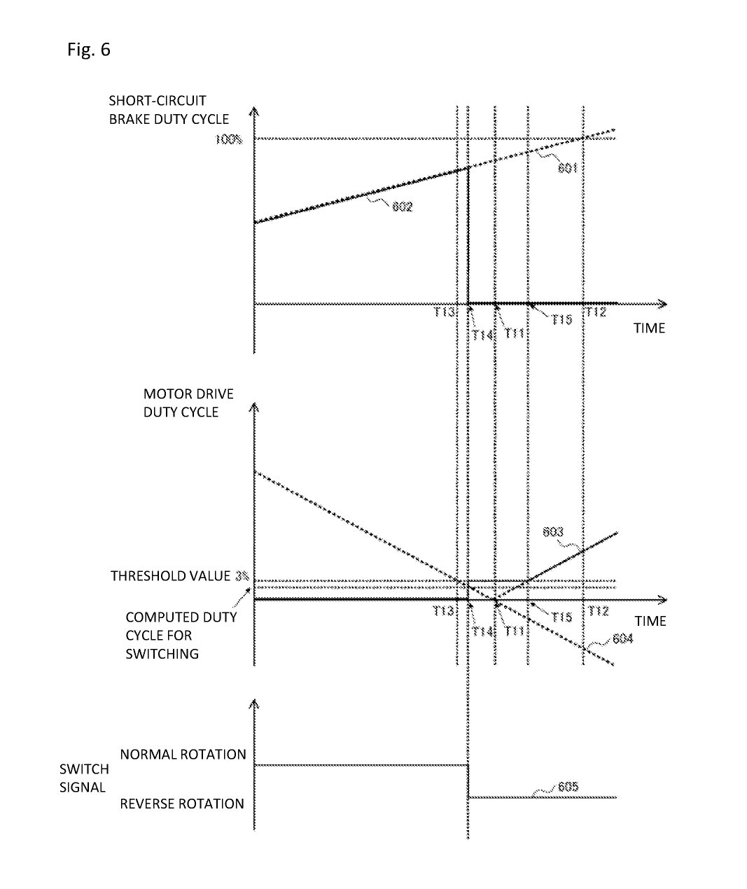

FIG. 6 illustrates an example in which the duty cycle for a short-circuit brake is below 100% and in a range such that the switching to a reverse brake can be smoothly performed. In the top graph, a dashed line 601 indicates the transition of the calculated value of the short-circuit brake duty cycle of the drive signal based on the target value and the speed information during a braking operation. In the second-row graph, a solid line 603 indicates the actual instruction value of the motor drive duty cycle, and a dashed line 604 indicates the calculated value of the motor drive duty cycle as converted for the case of reducing the speed by a regenerative brake of PWM control.

After the switch to the reverse brake, the motor drive duty cycle to be output by the control amount signal output unit 131 is determined on the basis of the motor drive calculated value of the duty cycle obtained by converting the duty cycle of the short-circuit brake at the time of switching for the case of reducing the speed by a regenerative brake. However, when the duty cycle is lower than a certain level, the dead band will be encountered where neither a torque nor a brake can be produced. Accordingly, when the dead band is encountered at the motor drive duty cycle of 2.8% or below, for example, the duty cycle is controlled to maintain 3% or more including some margin for an error. Thus, when the short-circuit brake is switched to the reverse brake at T14, while the calculate value drops below 3%, the control amount signal output unit 131 outputs 3%. Accordingly, the motor drive duty cycle is as indicated by the solid line 603.

The short-circuit brake can be switched to the reverse brake more smoothly when the electric current through the coils of the motor 170 is smaller. Meanwhile, in light of the dead band, T13 in FIG. 6 is the timing of the lower limit of the duty cycle of the short-circuit brake suitable for switching. The interval between this and T12 at which the duty cycle of the short-circuit brake becomes 100% is the range enabling a smooth switch from a short-circuit brake to a reverse brake. More preferably, the range may be from T15 to T12 where the correction for the dead band is not performed.

In FIG. 5 and FIG. 6, for sake of brevity, the examples of the change in duty cycle have been illustrated using linear functions. However, the change in duty cycle is not limited to a linear function, and may be applied in the case of a multi-degree function or an exponential function, or in a non-linear case.

### Summary of Second Embodiment

As described in the second embodiment, during the braking operation using a short-circuit brake instead of a regenerative brake, too, a control similar to PWM control is performed. Accordingly, when the braking by a short-circuit brake is unable to reach the target value even if the duty cycle is 100%, the motor 170 can be braked to the target value by switching the torque generation direction of the motor 170 and thereby providing the function of a reverse brake.

### <Supplementary Notes>

The control device is not limited to the embodiments and may be implemented using other techniques. In the following, various modifications are described.

(1) While in the embodiments the control device 100 has been described as receiving the target value from an external device to control the motor 170, this is not intended as a limitation. The control device 100 may generate the target value by itself and implement a control as part of a control program for controlling the motor 170 in accordance with the purpose of the device equipped with the control device.

(2) While in the embodiments the control device 100 has been described as receiving the speed information from the ENC 171, this is not intended as limiting the manner in which the information concerning the drive state of the motor 170 is obtained. For example, the speed information may be obtained using a Hall element attached to the motor 170.

(3) While in the embodiments the control device 100 and the gate driver IC 150 have been described as being separate devices, this is not intended as a limitation. The control device 100 may be configured to control the motor 170 directly, without providing the gate driver IC 150. Specifically, the control device 100 may be provided with the function for applying an effective voltage corresponding to the determined duty cycle, and the function for controlling the ON/OFF of the transistors 161 to 166.

(4) In the embodiments, the control amount signal output unit 131, the switch signal output unit 132, and the drive signal output unit 133 are each connected with the gate driver IC 150 by a single signal line, and the operation of the motor is controlled by the High and Low of the voltage applied to the signal line. This is not intended as a limitation, and the switch signal may be implemented in the following modes.

For example, two signal lines may be used to send the instructions for forward rotation and reverse rotation, together with the braking amount signal indicating the duty cycle. For example, when the two signal lines are respectively designated a first signal line and a second signal line, the braking amount signal may be sent out to the first signal line in the case of forward rotation, and the braking amount signal may be sent out to the second signal line in the case of reverse rotation, thus implementing the braking amount signal and the switch signal. In addition, the drive signal may be implemented by turning OFF both of the signals on the first signal line and the second signal line for BRAKE, for example. In this case, the driving of the motor can be controlled with the two signal lines.

(5) In the embodiments, the duty cycle has been described as being determined on the basis of the speed information. However, instead of the speed information per se, a position deviation based on the speed information may be used for the control. In the case of the control using the position deviation, it may become possible to perform the braking to stop the motor 170 more smoothly and accurately.

(6) In the embodiments, the control unit 130 determines its output on the basis of the target value and the speed information received by the input unit 110. However, the output may be determined on the basis of a predicted value predicted and computed on the basis of the target value and the speed information received by the input unit 110. In this way, when the processing speed is considered important, such as during high-speed rotation, it becomes possible to prevent a delay or to complement a processing delay. In this way, the delay in the timing of switching from a regenerative brake or a short-circuit brake to a reverse brake may be eliminated, and a smoother switching may be performed.

(7) While in the embodiments the examples have been described in which PWM control is used and the control amount signal is output as the motor drive duty cycle, this is not intended as a limitation. For example, instead of the duty cycle, an analog value of voltage or a frequency signal may be used.

(8) In the embodiments, the technique for braking the motor has been described where the processor in the control device executes a control program and the like. Alternatively, this may be implemented by a logic circuit (hardware) or a dedicated circuit formed in the device in the form of an integrated circuit (IC) chip or a large scale integration (LSI) circuit, for example. These circuits may be implemented on one or a plurality of integrated circuits. The functions of the plurality of function units described in the embodiments may be implemented on a single integrated circuit. The LSI may be referred to as VLSI, super LSI, or ultra LSI, depending on the degree of integration.

The control program may be recorded on a recording medium that the processor can read. The recording medium may include non-transitory tangible media, such as tapes, discs, cards, semiconductor memories, and programmable logic circuits. The control program may also be supplied to the processor via arbitrary transmission media capable of transmitting the control program (such as communication networks and broadcast waves). The present invention may be implemented in the form of a data signal in which the control program is embodied by an electronic transmission and which is embedded in a carrier wave.

The control program may be implemented using script languages such as ActionScript and JavaScript (registered trademark); object-oriented programming languages such as Objective-C, Java(registered trademark); or markup languages such as HTML5.

(9) The configurations indicated in the embodiments and the configurations indicated in the Supplementary Notes may be combined, as appropriate.

What is claimed is:

1. A control device for controlling a motor which is driven by being applied with an effective voltage corresponding to a control amount of a control amount signal, and in which, when an inversely induced voltage of the motor exceeds the applied voltage, a rotational motion of a rotating shaft of the motor is converted into electric energy for use as a brake,
the control device comprising:
a first reception unit that receives a target value of the rotational speed of the motor;
a second reception unit that receives speed information concerning the rotational speed of the motor;
a control amount signal output unit that, based on the speed information and the target value, determines the control amount, and that outputs the control amount signal;
and a switch signal output unit that, based on the control amount for causing a decrease in the rotational speed due to the brake and indicated by the speed information to reach the target value, outputs a switch signal for switching a torque generation direction of the motor.

2. The control device according to claim 1, wherein the switch signal output unit outputs the switch signal at the timing of the control amount for reaching the target value becoming zero.

3. The control device according to claim 1, wherein the control amount signal output unit outputs the control amount signal that is corrected so as to become greater than the control amount signal of a dead band in which neither a drive torque for driving the motor with the control amount signal nor a brake torque by the brake are produced.

4. The control device according to claim 3, wherein the switch signal output unit outputs the switch signal for switching the torque generation direction of the motor when the control amount for causing the decrease in the rotational speed due to the brake and indicated by the speed information to reach the target value has an absolute value less than or equal to an upper limit value of the control amount causing the dead band.

5. The control device according to claim 1, wherein the control amount signal output unit increases the control amount signal after the switch signal is output.

6. The control device according to claim 1, wherein the control amount signal output unit determines the control amount based on the target value and a speed deviation of the motor based on the speed information.

7. A control method for a control device controlling a motor which is driven by being applied with an effective voltage corresponding to a control amount of a control amount signal, and in which, when an inversely induced voltage of the motor exceeds the effective voltage being applied, a rotational motion of a rotating shaft of the motor is converted into electric energy for use as a brake, the control device having a dead band in which neither a drive torque for driving the motor with the control amount nor a brake torque by the brake are produced,
the control method comprising:
a first receiving step of receiving a target value of a rotational speed of the motor;
a second receiving step of receiving speed information concerning the rotational speed of the motor;
a control amount signal output step of determining the control amount based on the speed information and the target value, and outputting the control amount signal; and
a switch signal output step of outputting a switch signal for switching a torque generation direction of the motor when the control amount for causing a decrease in the rotational speed due to the brake and indicated by the speed information to reach the target value has an absolute value less than or equal to an upper limit value of the control amount causing the dead band.

8. A control device for controlling a motor which is driven by being applied with an effective voltage corresponding to a duty cycle of a control amount signal, and in which input terminals of the motor are short-circuited to convert rotating motion of a rotating shaft of the motor into thermal energy for use as a brake,
the control device comprising:
a first reception unit that receives a target value of a rotational speed of the motor;
a second reception unit that receives speed information concerning the rotational speed of the motor;
a control amount signal output unit which, based on the speed information and the target value, determines the duty cycle and outputs the control amount signal;
a drive signal output unit that outputs a drive signal for controlling the short circuit between the input terminals using a brake duty cycle; and
a switch signal output unit that outputs a switch signal for switching a torque generation direction of the motor, wherein
the control amount signal output unit has a dead band in which neither a drive torque for driving the motor with the control amount signal nor a brake torque by the brake are produced, and is provided with a conversion formula for converting an output value of the drive signal and an output value of the control amount signal output unit, and
the switch signal output unit outputs the switch signal in a range in which the brake duty cycle for causing a decrease in the rotational speed due to the brake and indicated by the speed information to reach the target value has a lower limit of a converted value obtained by converting an upper limit value of the duty cycle of the control amount signal in the dead band into the brake duty cycle, and an upper limit of 100%.
